(19) United States
(12) Patent Application Publication
(10) Pub. No.: US 2005/0258715 A1
(43) Pub. Date: Nov. 24, 2005

(54) Piezoelectric actuator having minimal displacement drift with temperature and high durability

(76) Inventor: Roderic A. Schlabach, Goshen, IN (US)

Correspondence Address: CTS CORPORATION, 905 W. BLVD. N, ELKHART, IN, 46514, US

(21) Appl. No.: 10/848,732

(22) Filed: May 19, 2004

(51) Int. Cl. H02N 2/00

(52) U.S. Cl. 310/331

(57) ABSTRACT

A piezoelectric bending actuator that is insensitive to temperature changes. The actuator includes a pair of piezoelectric layers. One of the layers bends in response to an applied voltage and the other piezoelectric layer flattens in response to an applied voltage. The piezoelectric layers are mounted adjacent to each other. The piezoelectric layers move opposite to each other in response to a change in temperature such that the piezoelectric bending actuator is stable over a range of temperatures. The piezoelectric layers are held in compression between a ring and a retainer. Compressing the piezoelectric layers allows the bending actuator to have a high stroke with improved durability because the discs are kept in compression.

### BACKGROUND

The present invention relates to actuators in general and in particular to a piezoelectric actuator that has a stable response over a wide range of operating temperatures.

Piezoelectric devices alter their shape in response to an applied electric field. An electric field applied in the direction of polarization effects an expansion or contraction of the piezoelectric material in various directions. A voltage applied in the opposite direction of polarization causes a contraction or expansion of the material in those same directions.

Piezoelectric bending actuators, such as thermally pre-stressed bending actuators curve or bend under an applied voltage. These actuators convert electrical energy into mechanical movement and/or force. Various bending actuators have been used.

Unfortunately, the performance of piezoelectric bending actuators is quite temperature dependent. This limitation can present a problem in automotive or engine applications. An actuator in an automotive environment typically has to operate over a broad range of temperatures, such as −40 degrees Centigrade to +120 degrees Centigrade. Over wide temperature ranges, piezoelectric devices have force and displacement characteristics that change in response to changes in temperature of the device. A piezoelectric actuator that has a given axial displacement at one temperature will have a different displacement at a different temperature. In addition, the piezoelectric actuator will apply different predetermined forces or load at different temperatures. Temperature affects both displacement and drift. Displacement is the distance the actuator moves when energized. Drift is the shift in position of the actuator when it is not energized due to temperature effects.

The temperature dependence of piezoelectric bending actuators have been compensated to provide a more consistent and predictable movement. Various compensation means such as mechanical clamping, hydraulic systems and computer controlled feedback loops with temperature sensors have been used. However, these compensating methods add cost and complexity, and increase the overall size of the actuator device.

Another problem with piezoelectric bending actuators is durability. Piezoelectric bending actuators with a high stroke place the piezoelectric material in excessive tension. Piezoelectric materials have low tensile strength and are subject to breakage and failure.

A current unmet need exists for a piezoelectric bending actuator that has a stable displacement drift over a wide range of temperatures and improved durability.

### SUMMARY OF THE INVENTION

It is a feature of the present invention to provide a piezoelectric bending actuator that is insensitive to displacement drift with changing temperatures.

It is a feature of the present invention to provide a piezoelectric bending actuator that includes a first piezoelectric layer that bends in response to an applied voltage and a second piezoelectric layer that flattens in response to an applied voltage. The second piezoelectric layer is mounted adjacent to the first piezoelectric layer. The first and second piezoelectric layers move opposite to each other in response to a change in temperature such that the piezoelectric bending actuator is stable over a range of temperatures.

### BRIEF DESCRIPTION OF THE DRAWINGS

FIG. 1 is a perspective view of a piezoelectric bending actuator in accordance with the present invention.

FIG. 2 is an exploded view of the piezoelectric bending actuator of FIG. 1.

FIG. 3 is an enlarged cross-sectional view of one of the piezoelectric discs.

FIG. 4 is a cross-sectional view of the piezoelectric bending actuator of FIG. 1. taken along line 4-4.

FIG. 5 is a cross-sectional view of an uncompressed piezoelectric stack.

FIG. 6 is perspective view of an alternative terminal design.

FIG. 7 is perspective view of another alternative terminal design.

FIG. 8 is a view showing the electrical voltages applied to the piezoelectric discs to cause the actuator to move upwardly.

FIG. 9 is a view showing the electrical voltages applied to the piezoelectric discs to cause the actuator to move downwardly.

FIG. 10 is a view showing an alternative terminal design and applied voltages to cause the actuator to move upwardly.

FIG. 11 is a view showing an alternative terminal design and applied voltages to cause the actuator to move downwardly.

It is noted that the drawings of the invention are not to scale. In the drawings, like numbering represents like elements among the drawings.

### DETAILED DESCRIPTION

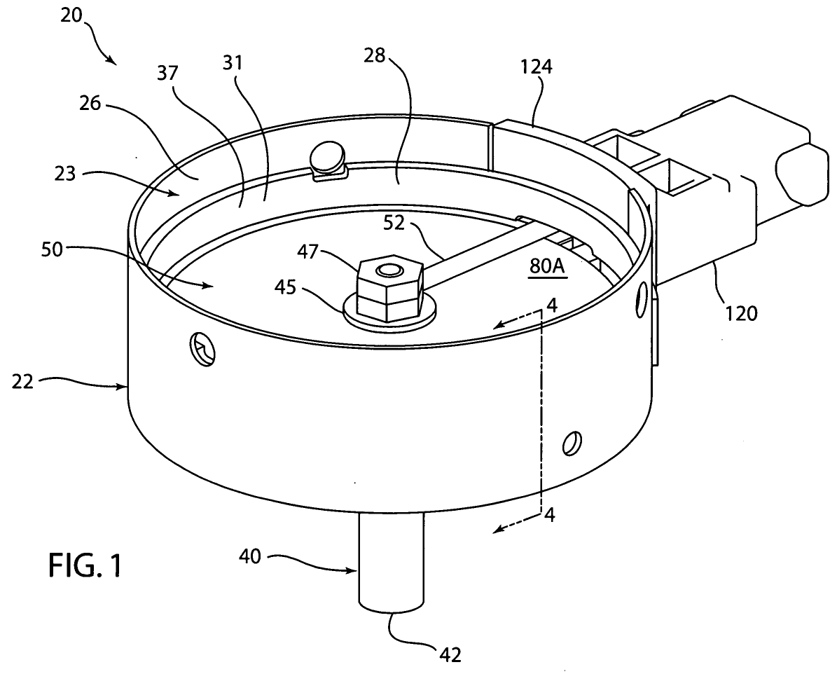

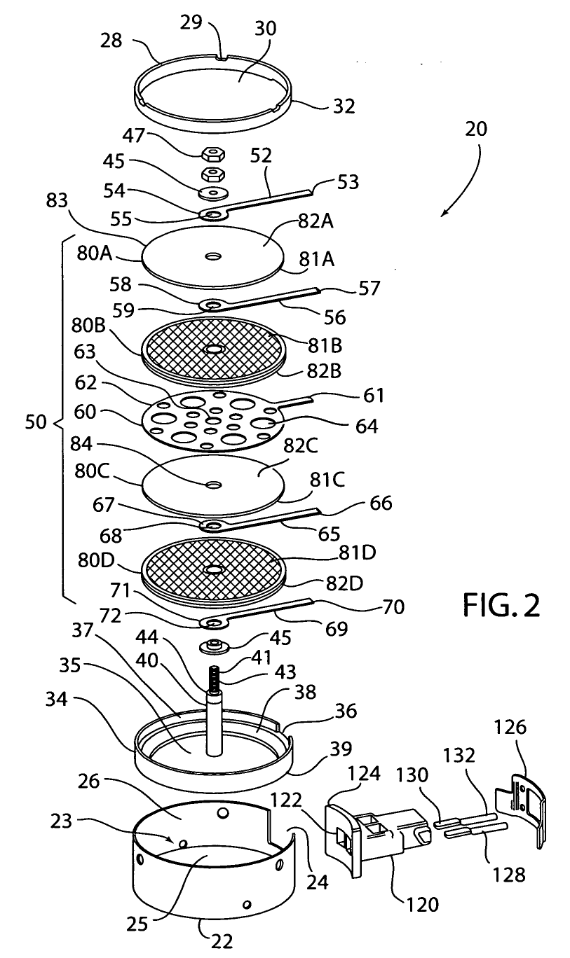

Referring to FIGS. 1-4, an embodiment of a piezoelectric bending actuator assembly 20 is shown. Piezoelectric bending actuator 20 has a cylindrical shaped housing 22. Housing 22 has a cavity 23, slot 24, hole 25 and an inner wall 26. A ring 28 is mounted in cavity 23. Ring 28 has a slot 29, a hole 30, an inner wall 31, outer wall 32 and bottom 33. Ring 28 is laser welded to inner wall 26 of housing 22. Inner wall 31 and bottom 33 are coated with an insulating material such as ceramic. Housing 22 and ring 28 can be made out of a metal such as stainless steel.

A retainer 34 is mounted in cavity 23. Retainer 34 has a hole 35, slot 36, lip 37, upper surface 38 and lower surface 39. Retainer 34 can be made out of a metal such as stainless steel. Retainer 34 can also be made out of plastic or ceramic.

A piezoelectric stack 50 is compressed and mounted in cavity 23 between ring 28 and retainer 34. Piezoelectric stack 50 has four curved or domed piezoelectric layers or discs 80A, 80B, 80C, 80D and five terminals 52, 56, 60, 65 and 69. The outer edges of the discs are compressed between ring 28 and retainer 34.

Piezoelectric discs 80A-80D each have a convex shaped surface 81A, 81B, 81C and 81D, respectively. Piezoelectric discs 80A-80D also each have a concave shaped surface 82A, 82B, 82C and 82D, respectively. The piezoelectric discs each have an outer circumferential edge 83 and a central hole 84 that extends through all of the discs. After stacking, holes 84 are aligned with each other. While a circular disc is shown, other shapes such as square or rectangular can be used. The piezoelectric elements shown have a complex curvature. It is contemplated that the piezoelectric elements may also be of simple curvature with the same advantages.

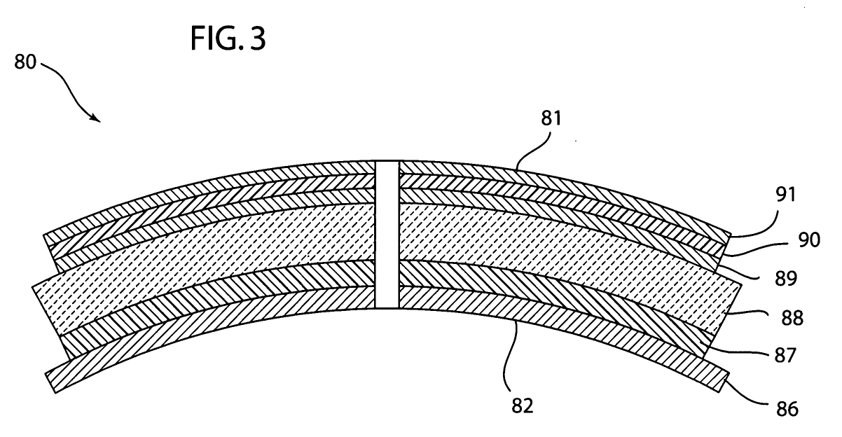

Referring to FIG. 3, an enlarged cross-sectional view of one of the piezoelectric discs 80 is shown. The piezoelectric disc has multiple laminated layers. A piezoelectric core 88 is attached to a thin steel stiffener 86 by an adhesive 87. The adhesive 87 can be a thermally-activated type adhesive. The steel stiffener forms the concave surface 82. Piezoelectric core 88 can be any active ceramic material, such as piezoelectric, electrostrictive or other ferroelectric materials.

A thin metal conductive coating 89 is applied to one side of piezoelectric core 88. The metal conductive coating 89 is typically applied by vacuum metallization and can be formed from nickel, silver, copper, aluminum, tin, gold, chromium or alloys thereof. A perforated copper foil electrode 91 is attached to conductive coating 89 by an adhesive 90. Adhesive 90 can be a thermally-activated type adhesive. Copper foil electrode 91 forms convex surface 81. It is noted that the thickness of layers 86, 87, 89, 90 and 91 are enlarged for clarification. During manufacturing, the adhesives 87 and 90 are applied between the piezoelectric core, the steel stiffener and the copper foil electrode. The resulting stack is heated to an elevated temperature where the adhesive flows. Typical temperatures are 100 degrees Centigrade to about 300 degrees Centigrade. Upon cooling, the core, stiffener and electrode are bonded together forming piezoelectric disc 80. Because of the difference in coefficients of thermal expansion of the core and stiffener as the layers cool to ambient temperature, they shrink at different rates causing mechanical stress to be imparted into the disc. This causes the disc to bend or dome in one direction forming the convex and concave surfaces.

In operation, an electrical voltage is applied to each side of the piezoelectric disc through the copper foil electrode and the steel stiffener. Depending upon the polarity of the voltage being applied, the piezoelectric disc 80 contracts or expands causing the disc to either flatten or dome (bend) higher, respectively.

Four of the piezoelectric discs 80A, 80B, 80C, 80D are arranged with five terminals 52, 56, 60, 65 and 69 to form piezoelectric stack 50. The terminals supply power to the piezoelectric discs. Terminal 52 is mounted above piezoelectric disc 80A adjacent to concave surface 82A. Terminal 52 has ends 53 and 54 and a hole 55. Terminal end 53 extends through slot 24. Terminal 56 is mounted between piezoelectric disc 80A and 80B. Terminal 56 has ends 57 and 58 and a hole 59. Terminal end 57 extends through slot 24. Terminal 60 is mounted between piezoelectric disc 80B and 80C. Terminal 60 has ends 61 and 62, a hole 63 and vent holes 64. Terminal end 61 extends through slot 24. Terminal 65 is mounted between piezoelectric disc 80C and 80D. Terminal 65 has ends 66 and 67 and a hole 68. Terminal end 66 extends through slot 24. Terminal 69 is mounted below piezoelectric disc 80D adjacent to concave surface 82D. Terminal 69 has ends 70 and 71 and a hole 72. Terminal end 70 extends through slot 24. The terminals can be made from brass.

During manufacturing the piezoelectric cores 88 are polarized. Polarization means that the dipoles of the material are aligned in a particular direction. Poling is done by applying a high DC voltage across core 88. Poling results in two polarities. Piezoelectric discs 80A and 80D are poled in one direction and piezoelectric discs 80B and 80C are poled in another direction. The piezoelectric discs are poled such that the discs alternate in their poling.

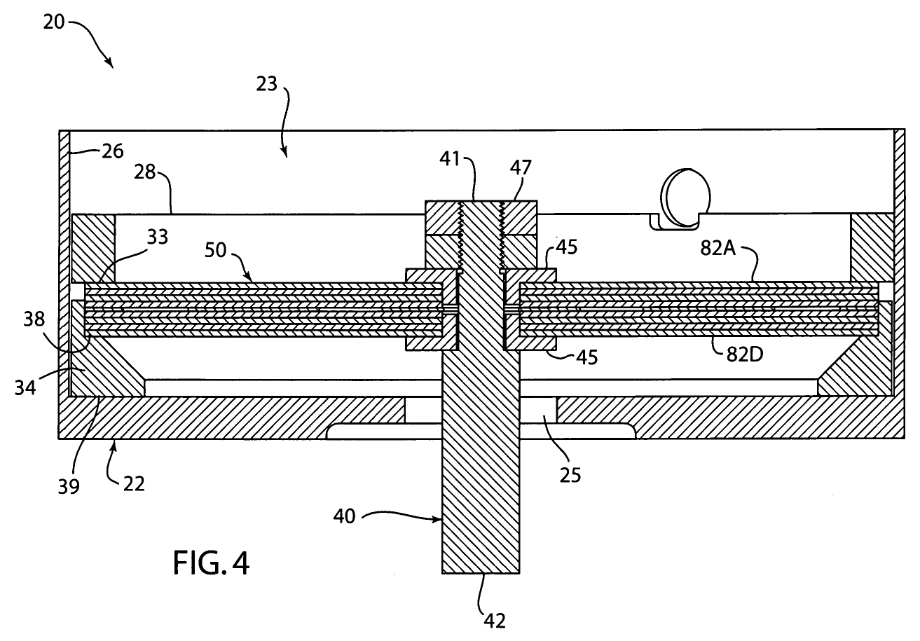

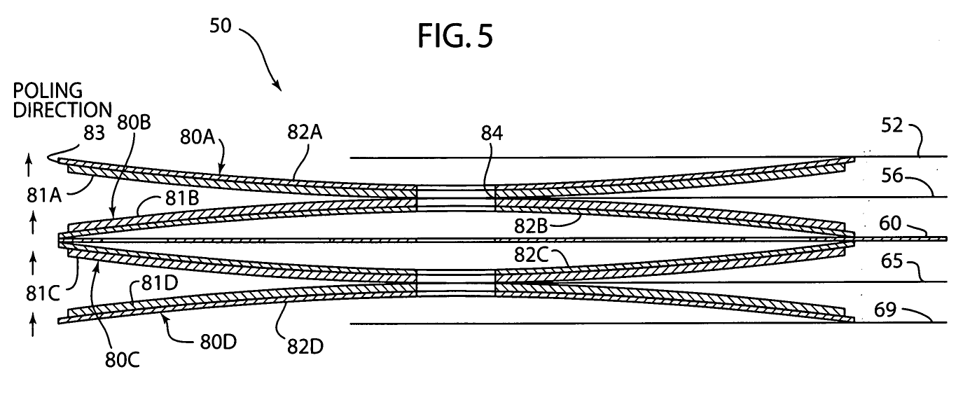

Referring to FIGS. 4 and 5, cross-sectional views of the piezoelectric bending actuator 20 are shown in a compressed and uncompressed state.

Piezoelectric discs 80A and 80B are stacked on top of each other or together with convex surfaces 81A and 81B (copper foil electrodes) facing each other. In this configuration, discs 80A and 80B touch at the center and bend away from each other toward the edge 83. Piezoelectric discs 80C and 80D are also stacked on top of each other with convex surfaces 81C and 81D (copper foil electrodes) facing each other. In this configuration, discs 80C and 80D touch at the center and bend away from each other at the edge 83.

Terminal 60 is mounted between piezoelectric discs 80B and 80C. Terminal 56 is mounted between piezoelectric discs 80A and 80B. Terminal 65 is mounted between piezoelectric discs 80C and 80D. Piezoelectric discs 80B and 80C have their concave surfaces 82B and 82C facing each other.

Piezoelectric discs 80A, 80B, 80C and 80D are shown in FIG. 5 before being compressed and mounted in cavity 23 of housing 22. FIG. 4 shows the piezoelectric discs after compression and assembly into cavity 23. The discs can be compressed with about 10 pounds of pre-load force.

A shaft 40 is located partially in cavity 23 and extends from actuator assembly 20. Shaft 40 has ends 41, 42 and a flange 44. End 41 has threads 43. End 42 extends away from housing 22. An object that is desired to be moved can be attached to end 42, such as a valve or fuel injector (not shown). Shaft 40 extends through holes 84 of piezoelectric discs 80A-80D, and holes 25, 30 and 35. Flange 44 rests against concave surface 82D. Spacers 45 are mounted on shaft 40 on each side of piezoelectric stack 50. Each spacer 45 projects into holes 84 and around shaft 40. Nuts 47 are attached to threads 43 to retain shaft 40 to piezoelectric stack 50.

The arrows in FIG. 5 show the direction of poling. Since the piezoelectric discs are stacked in an alternating manner, the resulting direction of poling is all in the same direction.

OPERATION

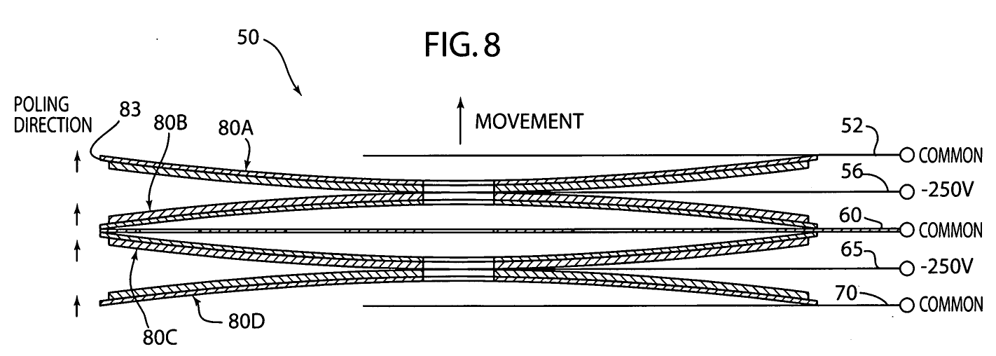

Turning now to FIG. 8, an example of the voltages applied to actuator assembly 20 are shown. When the shaft or center section of actuator 20 is desired to be moved upwardly, a voltage of −250 volts is applied to terminals 56 and 65. Terminals 52, 60 and 70 are commoned together as the return path. The voltage causes piezoelectric discs 80A and 80C to flatten. At the same time the applied voltage causes piezoelectric discs 80B and 80D to dome or bend more. The net result is that the center of the discsmove upwards.

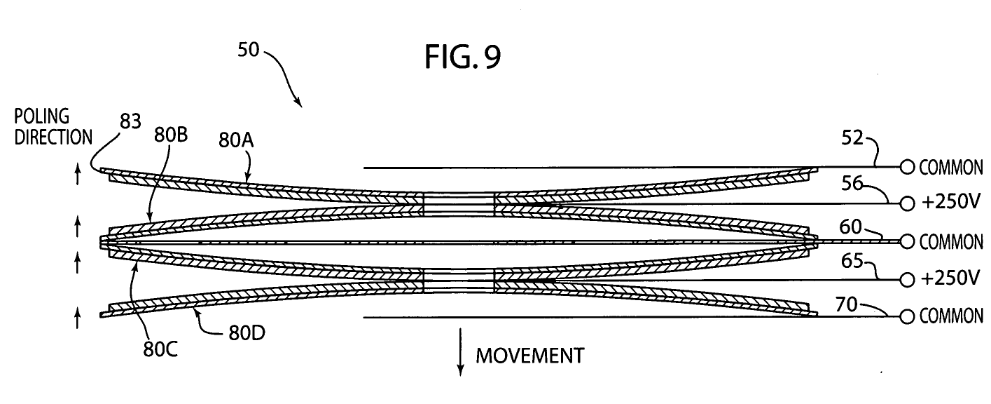

If the applied voltage polarity is reversed, piezoelectric discs 80A and 80C dome or bend more and piezoelectric discs 80B and 80D to flatten. FIG. 9 shows a voltage of +250 volts applied to terminals 56 and 65. Terminals 52, 60 and 70 are commoned together as the return path. The net result is that the center of the discs move downwards.

In most operating environments of piezoelectric bending actuator 20, wide variations in operating temperature can occur. For example, in a vehicle engine application, temperatures can vary between −40 and +120 degrees Centigrade.

In the situation where piezoelectric bending actuator 20 is subjected to an increasing temperature, piezoelectric discs 80A and 80C will attempt to elongate and flatten. At the same time, piezoelectric discs 80B and 80D will attempt to elongate and flatten. The net result is that shaft 40 has no net movement or displacement drift with an increase in temperature. The flattening of discs 80A and 80C is cancelled by the flattening of discs 80B and 80D. Piezoelectric discs 80A, 80B, 80C, and 80D will all elongate so that the difference of coefficients of thermal expansion between the core and stiffener will cause a decrease in the bend or doming of the piezoelectric discs. The amount of elongation or flattening for each disc is proportional to the temperature increase. Referring to FIG. 5, flattening out of disc 80A tends to move the center portion of the disc upward, while the flattening out of disc 80B tends to move the center downward. The same is true with discs 80C and 80D. Accordingly, when the actuator is assembled with shaft 40, the movement in opposite directions of disc 80A as compared to disc 80B and disc 80C as compared to disc 80D will result in no net movement or displacement drift of drive shaft 40 with an increase in temperature. Therefore, piezoelectric bending actuator 20 has a minimal displacement drift over a wide range of temperatures.

In the situation where piezoelectric bending actuator 20 is subjected to a decreasing temperature, piezoelectric discs 80A and 80C will contract and attempt to bend or dome higher. At the same time, piezoelectric discs 80B and 80D will attempt to dome higher. The net result is that shaft 40 has no net movement or displacement drift with a decrease in temperature. The bending of discs 80A and 80C is cancelled by the bending of discs 80B and 80D. Piezoelectric discs 80A, 80B, 80C, and 80D will all contract so that the difference of coefficients of thermal expansion between the core and stiffener will cause an increase in the bend or doming of the piezoelectric discs.

However, as edges 83 of the piezoelectric disc are restrained between ring 28 and retainer 34, convex surface 81A of disc 80A will try to move downward against convex surface 81B of disc 80B, which in turn will try to move upward. Accordingly, the bending forces will be pushing in opposite directions from one another and tend to cancel each other out so that the center portion does not move up or down. The same is true with discs 80C and 80D. In addition, as discs 80B and 80C try to dome with decreasing temperatures, outer edges 83 of concave surfaces 82B and 82C will also push against one another with an equal and opposite force. The net result being that when assembled, shaft 40 will have no net movement or displacement drift with a decrease in temperature.

Therefore, piezoelectric bending actuator 20 is has a minimal displacement drift over a wide range of temperatures.

In other words, the movement of one piezoelectric disc with temperature is offset by another piezoelectric disc due to their opposing orientations.

A typical displacement of shaft 40 is 0.2 millimeters. Piezoelectric actuator 20 can be operated at frequencies up to 1000 cycles per second.

Piezoelectric stack 50 is held in compression between ring 32 and retainer 34. Piezoelectric materials have a high strength in compression but are weak in tension. Compressing the piezoelectric stack 50 allows the bending actuator to have a high stroke with improved durability because the discs are always kept in compression.

### TESTING

A piezoelectric bending actuator 20 was built in accordance with the present invention and tested over a range of temperatures. The results of the tests are shown below in table 1. It can be seen that the piezoelectric bending actuator 20 has a stable displacement response over a wide range of temperatures.

TABLE 1

| | Displacement drift |
|---|---|
| Temperature in | (change in shaft position) |
| degrees Centigrade | In millimeters |
| 0 | .01 |
| 20 | .02 |
| 40 | .01 |
| 60 | .02 |
| 80 | .01 |
| 100 | .02 |
| 120 | .01 |

Piezoelectric bending actuator 20 was also tested for durability by mechanical cycling of the actuator over a stroke of 0.2 mm. Actuator 20 exhibited durability of greater than 800 million cycles without failure. In contrast, actuators of the prior art that are not compressed exhibited failure rates corresponding to a Weibull B50 life of approximately 8 million cycles.

### MANUFACTURING

Piezoelectric bending actuator assembly 20 can be assembled in the following sequence of steps:
1. The lower spacer 45 is placed on shaft 40.
2. Shaft 40 is placed through retainer 34.
3. Terminal 69 is placed on shaft 40.
4. Piezoelectric disc 80D is placed on shaft 40.
5. Terminal 65 is placed on shaft 40.
6. Piezoelectric disc 80C is placed on shaft 40.
7. Terminal 60 is placed on shaft 40.
8. Piezoelectric disc 80B is placed on shaft 40.
9. Terminal 56 is placed on shaft 40.
10. Piezoelectric disc 80A is placed on shaft 40.
11. Terminal 52 is placed on shaft 40.
12. The upper spacer 45 is placed on shaft 40.
13. Nuts 47 are screwed onto threads 43.
14. Retainer 34 is placed in housing 22.
15. Ring 28 is placed over piezoelectric disc 80A in cavity 23 and compressed.
16. Ring 28 is laser welded to inner wall 26 of housing 22.

### ALTERNATIVE TERMINAL EMBODIMENT

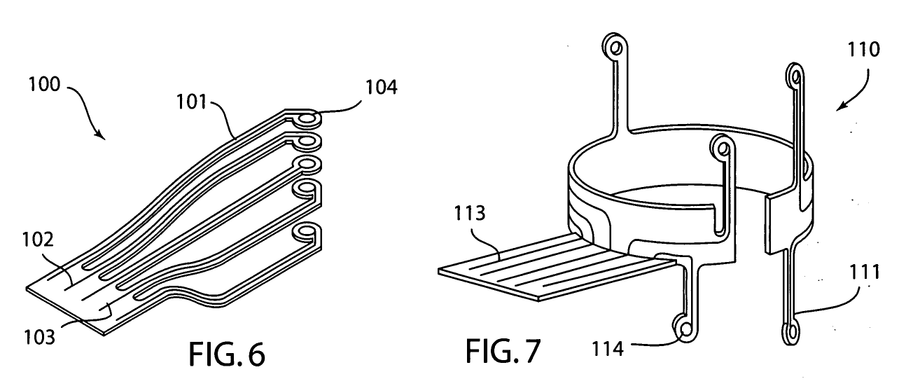

Referring to FIGS. 6 and 7, two alternative embodiments for the terminals are shown using a flexible polyimide film. FIG. 6 shows a terminal assembly 100 fabricated from a kapton film 102. Circuit lines 103 are fabricated on film 102. Kapton firm 102 is separated into five terminals 101. Terminals 101 correspond to individual terminals 52, 56, 60, 65 and 69. A hole 104 is located at the end of each terminal.

FIG. 7 shows a terminal assembly 110 fabricated from a kapton film 112. Circuit lines 113 are fabricated on film 102. Kapton firm 112 is separated into five terminals 111. Terminals 111 can be used instead of individual terminals 52, 56, 60, 65 and 69. A hole 114 is located at the end of each terminal. During assembly the terminals have enough flexibility to be aligned such that the shaft can pass through the holes.

### ALTERNATIVE EMBODIMENT

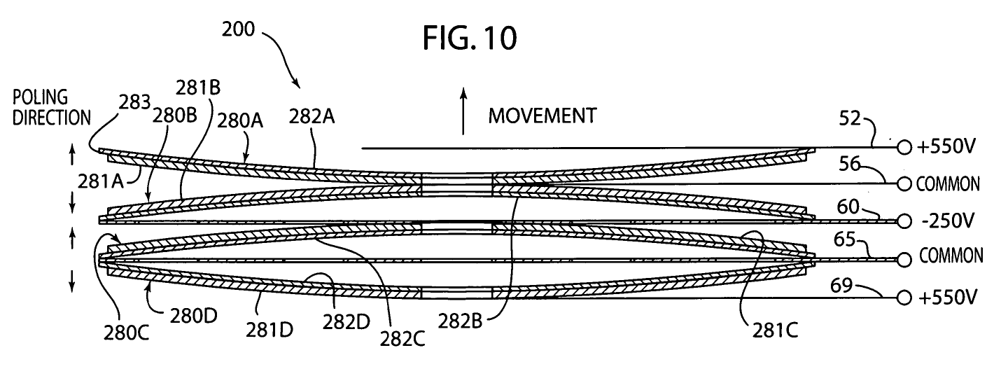

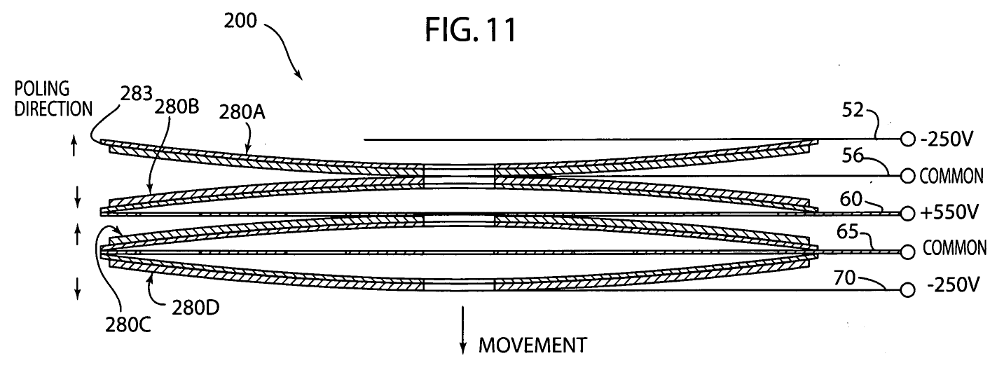

Referring to FIGS. 10 and 11, a three terminal piezoelectric stack 200 is shown. Piezoelectric stack 200 has four piezoelectric discs 280A, 280B, 280C, 280D are arranged with five terminals 52, 56, 60, 65 and 69 to form piezoelectric stack 200. The terminals supply power to the piezoelectric discs. Piezoelectric stack 200 would replace stack 50 in actuator assembly 20. The arrows under the heading, “poling direction”, adjacent each piezoelectric disc indicates the direction that each piezoelectric disc is poled. More or fewer piezoelectric discs can be used.

Piezoelectric discs 280A and 280B are stacked on top of each other with their convex surfaces (copper foil electrodes) facing each other. In this configuration, discs 280A and 280B touch at the center and bend away from each other toward the edge 283. Piezoelectric discs 280C and 280D are stacked on top of each other with their concave surfaces (steel stiffener) facing each other. In this configuration, discs 280C and 280D touch at edge 283.

Terminal 60 is mounted between piezoelectric discs 280B and 280C. Terminal 56 is mounted between piezoelectric discs 280A and 280B. Terminal 65 is mounted between piezoelectric discs 280C and 280D. Piezoelectric discs 280B and 280C are mounted such that the concave surface of disc 280B faces the convex surface of disc 280C.

In FIG. 10, the voltages applied to stack 200 are shown. When the shaft or center section of actuator 20 is desired to be moved upwardly, a voltage of +550 volts is applied to terminals 52 and 69. Terminals 56 and 65 are commoned together as the return path. Terminal 60 is connected to −250 volts. The voltage causes piezoelectric discs 80B and 80C to dome or bend more. At the same time the applied voltage causes piezoelectric discs 80A and 80D to flatten. The net result is that the center of the discs move upwards.

FIG. 11 shows a voltage of −250 volts applied to terminals 52 and 69. Terminals 56 and 65 are commoned together as the return path. Terminal 60 is connected to a voltage of +550 volts. These voltages cause piezoelectric discs 80B and 80C to flatten and piezoelectric discs 80A and 80D to dome or bend more. The net result is that the center of the discs move downwards.

The center of piezoelectric stack 200 typically moves or has a displacement of 0.3 millimeters. This is a larger displacement than for piezoelectric stack 50.

### ADVANTAGES OF THE INVENTION

One of ordinary skill in the art of designing and using actuators will realize many advantages from using the present invention. The piezoelectric actuator is self compensating for changes in temperature without the need for external compensation devices.

An additional advantage of the present invention is improved accuracy. The built in temperature compensation eliminates one of the major sources of actuator error.

Another advantage of the present invention is that the piezoelectric actuator is low in cost because none of the external temperature compensation components required by the prior art devices are required.

Another advantage of the present invention is improved reliability. The elimination of external temperature compensation components reduces the chance of component failure.

A further advantage of the present invention is that by the ring and retainer hold the piezoelectric discs in compression which improved reliability and durability of the actuator.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A piezoelectric bending actuator comprising:
a first piezoelectric layer adapted to bend in response to an applied voltage;
a second piezoelectric layer adapted to flatten in response to an applied voltage, the second piezoelectric layer mounted adjacent the first piezoelectric layer, the first and second piezoelectric layers moving opposite to each other in response to a change in temperature such that the piezoelectric bending actuator is stable over a range of temperatures.

2. The actuator according to claim 1, wherein the first and second piezoelectric layers are compressed and retained in a housing.

3. The actuator according to claim 1, wherein the first and second piezoelectric layer are compressed and retained in a housing along an outer peripheral edge.

4. The actuator according to claim 1, wherein the first and second piezoelectric layers are polarized opposite to each other.

5. The actuator according to claim 1, wherein an aperture extends through the center of the first and second piezoelectric layers.

6. The actuator according to claim 1, wherein the first piezoelectric layer has a first surface and a second surface, a first electrode mounted to the first surface and a second electrode mounted to the second surface, the second piezoelectric layer having a third surface and a fourth surface, a third electrode mounted to the third surface and a fourth electrode mounted to the fourth surface.

7. The actuator according to claim 6, wherein a terminal is mounted between the second and third electrodes.

8. The actuator according to claim 6, wherein a terminal is mounted to the first electrode and another terminal is mounted to the fourth electrode.

9. The actuator according to claim 6, wherein the first, second, third and fourth electrodes are formed from a rigid metal, the electrodes being glued to their respective surfaces.

10. The actuator according to claim 6, wherein the first and fourth electrodes are formed from steel and the second and third electrodes are formed from a perforated copper foil.

11. An actuator comprising:
a first piezoelectric layer having a top side and a bottom side, the first piezoelectric layer having a first polarity;
a second piezoelectric layer having a top side and a bottom side, the top side of the second piezoelectric layer adjacent the bottom side of the first piezoelectric layer, the second piezoelectric layer having a second polarity, the second piezoelectric layer polarity being opposite that of the first piezoelectric layer, the first and the second piezoelectric layers having opposite temperature responses such that such that the piezoelectric bending actuator is stable over a range of temperatures.

12. The actuator according to claim 11, wherein the first and second piezoelectric layer are compressed and retained in a housing.

13. The actuator according to claim 11, wherein an aperture extends through the center of the first and second piezoelectric layers.

14. The actuator according to claim 11, further comprising:
a first electrode mounted to the first piezoelectric layer top surface;
a second electrode mounted to the first piezoelectric layer bottom surface;
a third electrode mounted to the second piezoelectric layer top surface; and
a fourth electrode mounted to the second piezoelectric layer bottom surface.

15. The actuator according to claim 14, wherein a first terminal is mounted between the second and third electrodes.

16. The actuator according to claim 14, wherein a second terminal is mounted to the first electrode and a third terminal is mounted to the fourth electrode.

17. The actuator according to claim 14, wherein the first and fourth electrodes are formed from steel and the second and third electrodes are formed from a perforated copper foil, the electrodes being fastened to the piezoelectric layers with an adhesive.

18. A piezoelectric actuator comprising:
at least one first piezoelectric disc adapted to bend in response to an applied voltage;
at least one second piezoelectric disc adapted to flatten in response to the applied voltage, the second piezoelectric disc mounted adjacent the first piezoelectric disc;
the first and second piezoelectric discs moving between a first position and a second position in response to the applied voltage, the difference between the first and second positions defining a displacement, the piezoelectric discs reacting to changes in temperature such that the displacement is insensitive to temperature changes; and
a housing, the first and second piezoelectric discs mounted in the housing.

19. The actuator according to claim 18, wherein in response to an increasing temperature, the first and second piezoelectric discs flatten.

20. The actuator according to claim 18, wherein in response to a decreasing temperature, the first and second piezoelectric discs bend more.

21. The actuator according to claim 18, wherein in response to a change in temperature the first and second piezoelectric discs move to offset each other such that no net displacement results.

22. An actuator comprising:
a first dome shaped piezoelectric disc having a first concave surface and a first convex surface, the first piezoelectric disc adapted to bend in response to an applied voltage;
a second dome shaped piezoelectric disc having a second concave surface and a second convex surface, the second piezoelectric disc adapted to flatten in response to an applied voltage; and
the first and second convex surfaces mounted adjacent each other.

23. The actuator according to claim 22, wherein the first and second piezoelectric discs are mounted in a housing.

24. The actuator according to claim 22, wherein the first and second piezoelectric discs having an outer peripheral edge and a center portion, a hole extending through the discs in the center portion, the piezoelectric discs connectable with a movable object through the hole.

25. The actuator according to claim 22, wherein in response to a change in temperature the first and second piezoelectric discs bend or flatten such that the motion of the first disc offsets the motion of the second disc.

26. The actuator according to claim 22, further comprising:
a third dome shaped piezoelectric disc having a third concave surface and a third convex surface, the third piezoelectric disc adapted to bend in response to an applied voltage;
a fourth dome shaped piezoelectric disc having a fourth concave surface and a fourth convex surface, the fourth piezoelectric disc adapted to flatten in response to an applied voltage;
the third and fourth convex surfaces mounted adjacent each other; and
the second concave surface mounted adjacent the third concave surface.

27. The actuator according to claim 26, further comprising:
a first terminal affixed to the first concave surface;
a second terminal affixed between the first and second convex surfaces;
a third terminal affixed between the second concave surface and the third concave surface;
a fourth terminal affixed between the third and fourth convex surfaces; and
a fifth terminal affixed to the fourth concave surface.

28. An actuator comprising:
a first dome shaped piezoelectric disc having a first concave surface and a first convex surface;
a second dome shaped piezoelectric disc having a second concave surface and a second convex surface, the first and second convex surfaces mounted facing each other;
a third dome shaped piezoelectric disc having a third concave surface and a third convex surface;
a fourth dome shaped piezoelectric disc having a fourth concave surface and a fourth convex surface;
the third and fourth concave surfaces mounted facing each other; and
the second concave surface mounted adjacent the third convex surface.

29. The actuator according to claim 28, further comprising:
a first terminal mounted adjacent the first concave surface;
a second terminal mounted between the first and second convex surfaces;
a third terminal mounted between the second concave surface and the third convex surface;
a fourth terminal mounted between the third and fourth concave surfaces; and
a fifth terminal mounted adjacent the fourth convex surface;

30. The actuator according to claim 29 wherein a first voltage is applied to the first and, fifth terminal, a second voltage is applied to the third terminal and a third voltage is applied to the second and fourth terminals.

31. A piezoelectric bending actuator comprising:
a ring;
a retainer; and
a plurality of piezoelectric discs held in compression between the ring and the retainer, the mounting of the discs in compression preventing operation of the discs in a state of tension.

32. The piezoelectric bending actuator according to claim 31, wherein the piezoelectric discs are held between the ring and retainer along an outer edge such that a center of the piezoelectric discs are free to move.

33. The piezoelectric bending actuator according to claim 31, wherein the ring and retainer are mounted in a housing.

34. The piezoelectric bending actuator according to claim 31, wherein the piezoelectric discs comprise four piezoelectric discs.

35. The piezoelectric bending actuator according to claim 31, wherein the piezoelectric discs comprise a first, second, third and fourth piezoelectric disc, the first and second piezoelectric discs having adjacent convex surfaces and the third and fourth piezoelectric discs having adjacent convex surfaces, the second and third piezoelectric discs having adjacent concave surfaces.

36. The piezoelectric bending actuator according to claim 31, wherein the piezoelectric discs comprise a first, second, third and fourth piezoelectric disc, the first and second piezoelectric discs having adjacent convex surfaces and the third and fourth piezoelectric discs having adjacent concave surfaces, the second piezoelectric disc having a concave surface adjacent a convex surface of the third piezoelectric disc.

37. The piezoelectric bending actuator according to claim 31, wherein terminals are mounted between each of the piezoelectric discs.

38. The piezoelectric bending actuator according to claim 31, wherein adjacent piezoelectric discs are oppositely poled.

39. The actuator assembly according to claim 30, wherein at least one of the piezoelectric discs is polarized in a direction opposite from the others.

40. The actuator assembly according to claim 30, wherein the polarity of the second voltage is opposite the polarity of the first and third voltage.
